(19) United States
(12) Patent Application Publication
(10) Pub. No.: US 2016/0380391 A1
(43) Pub. Date: Dec. 29, 2016

(54) ELECTRICAL CONNECTOR ASSEMBLY

(71) Applicant: Caterpillar Underground Mining Pty. Ltd., South Burnie (AU)

(72) Inventors: Noel T. Theodosiou, Burnie (AU); Paul T. Willetts, Devonport (AU)

(73) Assignee: Caterpillar Underground Mining Pty. Ltd., South Burnie (AU)

(21) Appl. No.: 14/751,341

(22) Filed: Jun. 26, 2015

(51) Int. Cl. H01R 13/66; H01R 43/20

(52) U.S. Cl. CPC H01R 13/665; H01R 43/205

(57) ABSTRACT

An electrical connector assembly is provided. The electrical connector assembly includes a receptacle. The receptacle includes a plurality of embedded pins. The electrical connector assembly also includes a printed circuit board coupled to the plurality of embedded pins of the receptacle. The printed circuit board includes a plurality of interconnected tracks provided thereon. The plurality of interconnected tracks is arranged in a side by side relationship. Each of the plurality of interconnected tracks including a plurality of through holes. The embedded pins extend from the receptacle and are received into the respective through holes of the printed circuit board.

### TECHNICAL FIELD

The present disclosure relates to a receptacle, and more particularly to the receptacle for an electrical connector assembly

### BACKGROUND

Identification of a correct pin splice for specific use is sometimes troublesome as external structural features of many of the available electrical connector assemblies are similar. This sometimes leads to inadvertent fitting of incorrect pin splices during assembly or maintenance. Further, the pin splice arrangement accommodating many pins, for example, 40 pins, occupy considerable space and have a bulky design. Utilizing such electrical connector assemblies having the bulky design may be difficult to install and accommodate in an environment having space constraints.

U.S. Pat. No. 7,351,106 describes an electrical connector for mounting on an external printed circuit board. The electrical connector comprises an insulative housing having a front mating face, a mounting face, a plurality of passageways extending rearwardly from the mating face, a receiving cavity extending through the mounting face and communicating with the passageways; an inner module received in the receiving cavity and including a front contact module having a front insulative block and a plurality of front contacts mounted thereon and extending into corresponding passageways, a rear contact module having a rear insulative block and a plurality of rear contacts mounted thereon and extending beyond the mounting face for being mounted on the external printed board, and an inner printed circuit board sandwiched between the front insulative block and the rear insulative block and electrically connecting the front contacts with the rear contacts.

### SUMMARY OF THE DISCLOSURE

In one aspect of the present disclosure, an electrical connector assembly is provided. The electrical connector assembly includes a receptacle. The receptacle includes a plurality of embedded pins. The electrical connector assembly also includes a printed circuit board coupled to the plurality of embedded pins of the receptacle. The printed circuit board includes a plurality of interconnected tracks provided thereon. The plurality of interconnected tracks is arranged in a side by side relationship. Each of the plurality of interconnected tracks including a plurality of through holes. The embedded pins extend from the receptacle and are received into the respective through holes of the printed circuit board.

In another aspect of the present disclosure, an electrical connector assembly is provided. The electrical connector assembly includes an enclosure. The electrical connector assembly includes a receptacle. The receptacle includes a plurality of embedded pins. The electrical connector assembly also includes a printed circuit board coupled to the plurality of embedded pins of the receptacle. The printed circuit board includes a plurality of interconnected tracks provided thereon. The plurality of interconnected tracks is arranged in a side by side relationship. Each of the plurality of interconnected tracks including a plurality of through holes. The embedded pins extend from the receptacle and are received into the respective through holes of the printed circuit board. Further, the receptacle and the printed circuit board are received into the enclosure.

In yet another aspect of the present disclosure, a method of arranging forty pins associated with a receptacle is provided. The method includes providing a plurality of interconnected tracks on a printed circuit board. The plurality of interconnected tracks includes a plurality of through holes in an 8×5 arrangement. The method also includes coupling a plurality of embedded pins associated with the receptacle with the plurality of through holes.

Other features and aspects of this disclosure will be apparent from the following description and the accompanying drawings.

### BRIEF DESCRIPTION OF THE DRAWINGS

FIG. 1 is a perspective view of an electrical connector assembly, according to one embodiment of the present disclosure;

FIG. 2 is an exploded view of the electrical connector assembly of FIG. 1;

FIG. 3 is a top view of a receptacle of the electrical connector assembly;

FIG. 4 is a front view of a printed circuit board associated with the electrical connector assembly; and

FIG. 5 is a flowchart for a method of arranging forty pin splices associated with the receptacle.

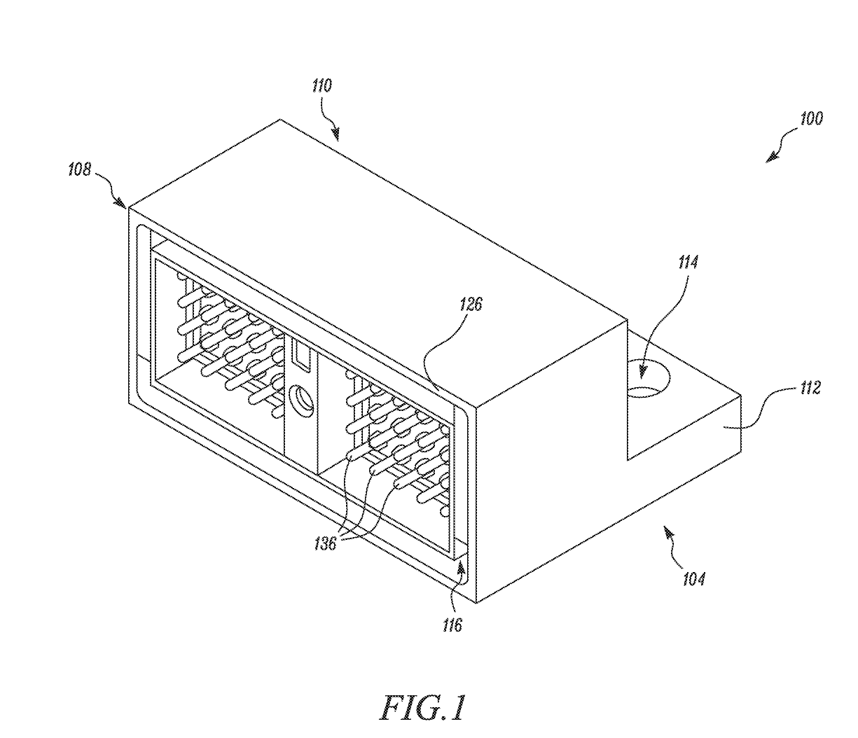

### DETAILED DESCRIPTION

Wherever possible, the same reference numbers will be used throughout the drawings to refer to the same or the like parts. FIG. 1 is a perspective view of an exemplary electrical connector assembly 100, according to one embodiment of the present disclosure. The electrical connector assembly 100 is configured to distribute power and signals through an electrical control system. In an exemplary embodiment, the electrical connector assembly 100 may be associated with underground machines. In some examples, the electrical connector assembly 100 may provide electrical connection between a cable (not shown) and a mating receptacle (not shown). The mating receptacle may include a number of sockets to receive pins of the electrical connector assembly 100.

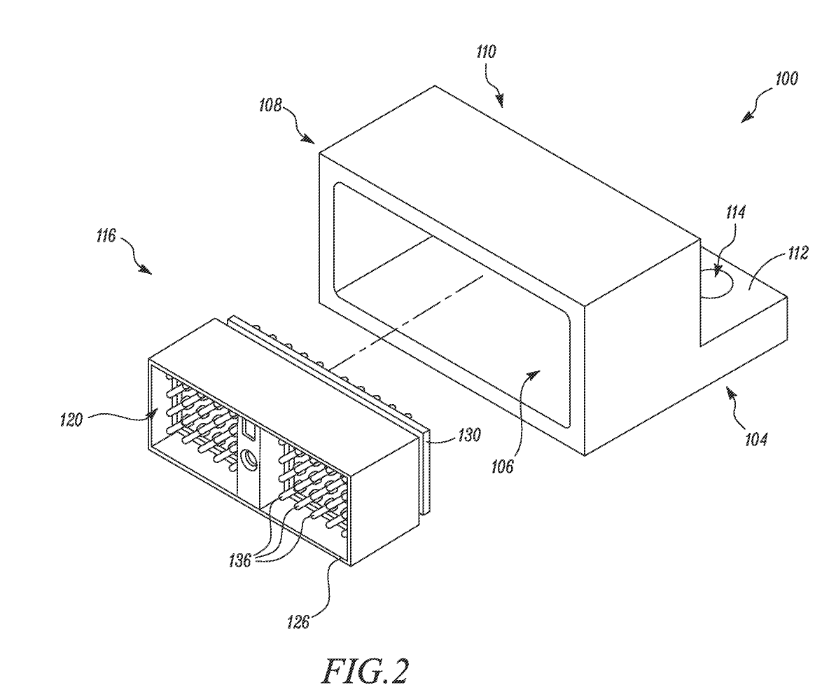

FIG. 2 is an exploded view of the electrical connector assembly 100. The electrical connector assembly 100 includes an enclosure 104. The enclosure 104 defines an interior space 106 therewithin. The enclosure 104 has an open end 108 and a closed end 110. The enclosure 104 has a rectangular cross section.

The enclosure 104 includes an extension portion 112. The extension portion 112 is provided at the closed end 110 of the enclosure 104. The extension portion 112 includes apertures 114 to receive mechanical fasteners (not shown) to couple the enclosure 104 to a work surface (not shown). The enclosure 104 may be made of a metal or a non-metal, as per system requirements. In one example, the enclosure 104 may embody a molded plastic enclosure, without limiting the scope of the present disclosure

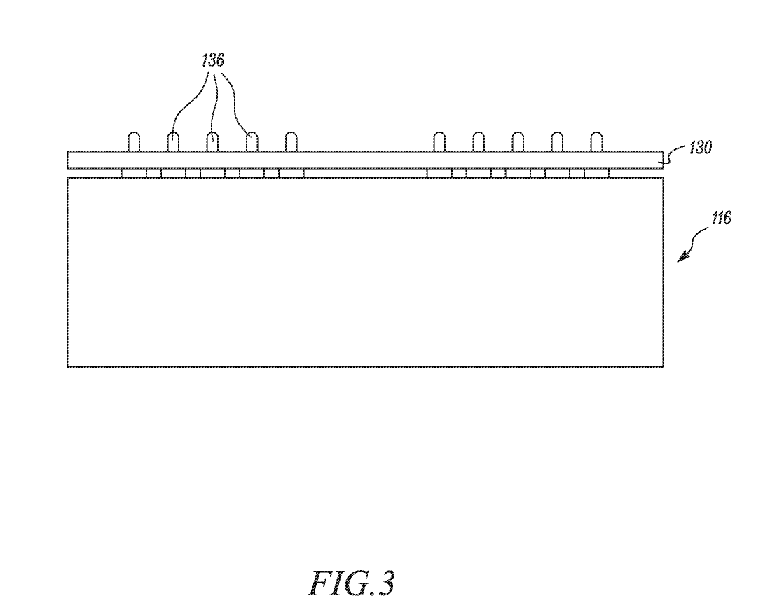

Referring to FIGS. 2 and 3, the electrical connector assembly 100 includes a receptacle 116. The receptacle 116 is configured to be coupled to the enclosure 104 of the electrical connector assembly 100. The receptacle 116 is received into the interior space 106 of the enclosure 104 through the open end 108. The receptacle 116 defines an interior space 120 therewithin. The receptacle 116 has a rectangular cross section. Referring to FIGS. 1, 2 and 3, the receptacle 116 includes a number of the embedded pins 136. The embedded pins 136 may embody conductive pins that allow an electric current to pass therethrough. In one example, the embedded pins 136 may include printed circuit board pins. The embedded pins 136 are received into the receptacle 116 such that the embedded pins 136 flush with a surface 126 of the receptacle 116.

As shown in FIGS. 2, 3, and 4, the electrical connector assembly 100 includes a printed circuit board 130. The printed circuit board 130 is coupled to a portion of the embedded pins 136 that extend out of the receptacle 116 (see FIG. 3). A perimeter of the printed circuit board 130 is decided such that the printed circuit board 130 fits into the interior space 120 of receptacle 116. In one example, the printed circuit board 130 may embody a double sided printed circuit board. During assembly, the printed circuit board 130 may be coupled or fitted over the embedded pins 136 using soldering or brazing.

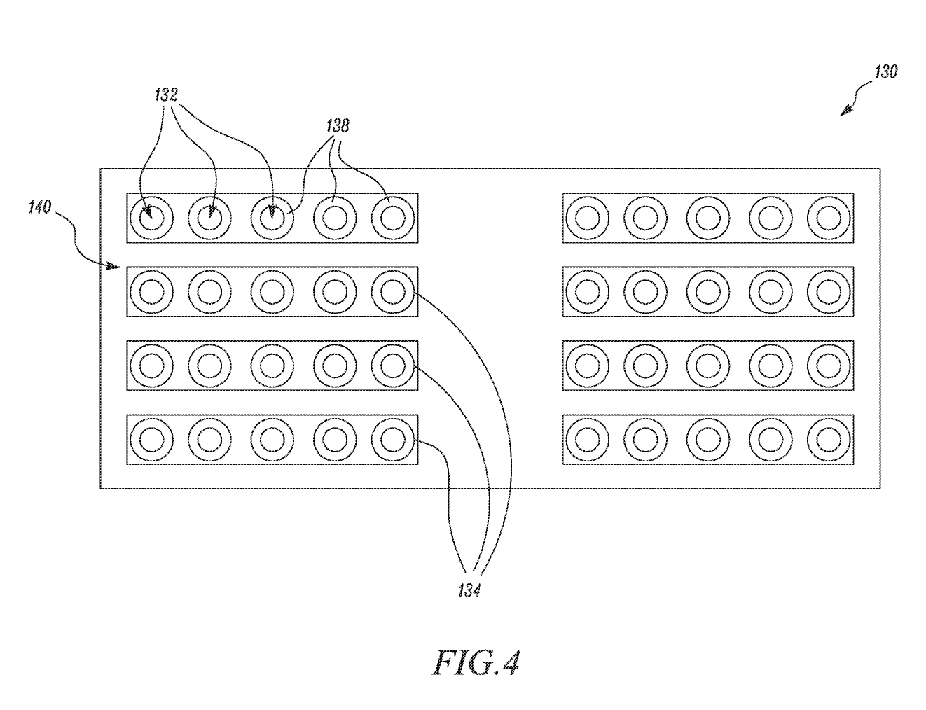

Referring to FIG. 4, the printed circuit board 130 includes a number of interconnected tracks 140. The tracks 140 are provided on the printed circuit board 130 in a side by side relationship. The interconnected tracks 140 are arranged in a number of segments 134. Each segment 134 in turn includes a number of through holes 132. Further, a copper pad 138 is provided in a surrounding relationship with each of the through holes 132. The embedded pins 136 extending from the receptacle 116 are received into the respective through holes 132 of the printed circuit board 130. Each segment 134 includes five or more through holes 132. In one example, the segment 134 includes five through holes 132. In such an example, the printed circuit board 130 includes eight numbers of the segments 134, such that the printed circuit board 130 includes forty through holes 132 in total. More particularly, the through holes 132 are arranged in a series of 8×5 pin slices.

As shown in FIGS. 2, 3, and 4, the embedded pins 136 are coupled with the through holes 132 of the printed circuit board 130. When coupled with the printed circuit board 130, the embedded pins 136 pass through and extend from the printed circuit board 130 (see FIGS. 2 and 3). The embedded pins 136 may be coupled with the printed circuit board 130 using soldering or brazing. In an example wherein the printed circuit board 130 includes forty through holes 132, the receptacle 116 will include corresponding number of embedded pins 136, thereby forming an 8×5 bussed receptacle. The pin configuration described herein is exemplary and does not limit the scope of the present disclosure. The pin configuration of the receptacle 116 may be expanded based on system requirements.

Referring to FIGS. 1 and 2, the receptacle 116 including the embedded pins 136, and the printed circuit board 130 coupled therewith using the embedded pins 136, form a unit configured to be received into the enclosure 104. The receptacle 116 is externally configurable via the embedded pins 136. More particularly, the embedded pins 136 may be externally looped such that the voltage across all the externally configured pins is the same. In some examples, each track 140 and the corresponding embedded pins 136 may be connected to other tracks 140 and the corresponding pins, so as to form a group. In such examples, the current across all the embedded pins in the group so formed will be the same. Further, in one example, all the corresponding pins 136 can be externally configured such that the voltage across all the embedded pins 136 of the receptacle 116 is the same.

As discussed earlier, the receptacle 116 is provided within the interior space 106 of the enclosure 104. An appropriate potting material (not shown) may be provided in surrounding contact with the enclosure 104 and the receptacle 116. The potting material is configured to insulate the receptacle 116 from the enclosure 104. The potting material acts as an encapsulating agent to environmentally seal the receptacle 116 from ingress of water or debris. In one example, an epoxy potting compound may be used as the potting material. Alternatively, any resin having insulating properties may be sued as the potting material.

### INDUSTRIAL APPLICABILITY

The electrical connector assembly 100 of the present disclosure includes the receptacle 116. The receptacle 116 includes embedded or molded pins 136 which are in turn coupled with the through holes 132 of the printed circuit board 130. The embedded pins 136 of the receptacle 116 can be externally configured in order to link the embedded pins 136 with each other so that the same voltage is obtained across each embedded pin 136 of the receptacle 116. Alternatively, each embedded pin 136 of the receptacle 116 can be used individually, as per system requirements.

The electrical connector assembly 100 includes lesser number of spare parts, thereby reducing complexity and providing easy handling of the electrical connector assembly 100. Further, the electrical connector assembly 100 is easy to assemble and occupies less space. Also, the electrical connector assembly 100 allows a number of the embedded pins to be accommodated in a relatively small footprint having a compact design. The electrical connector assembly 100 required for a particular application can be easily identified from other available connectors due to the pin configuration provided therewith. Thus, the probability of inadvertently identifying an incorrect pin during assembly/maintenance is reduced.

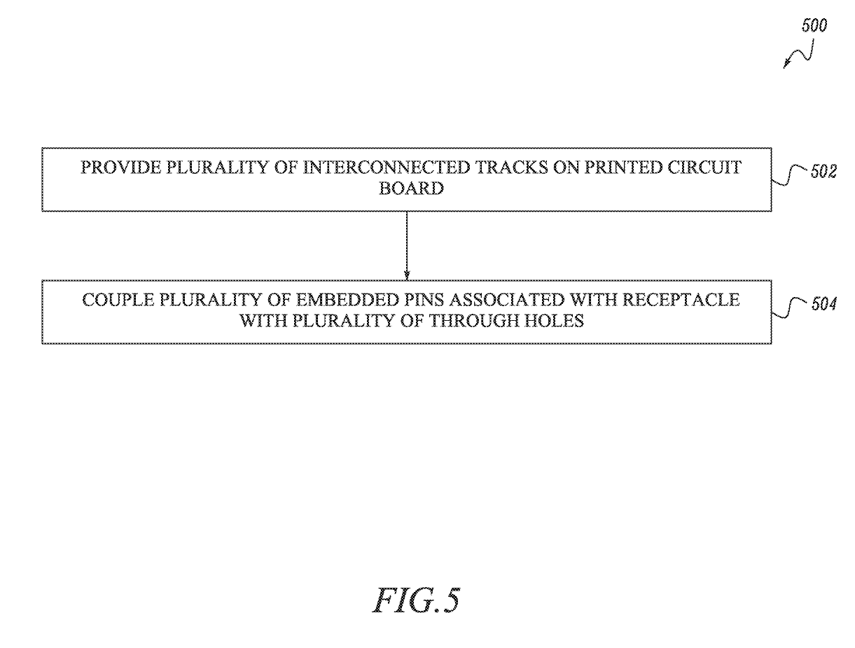

FIG. 5 is a flowchart for a method 500 of arranging the forty pins associated with the receptacle 116. At step 502, the interconnected tracks 140 are provided on the printed circuit board 130. The interconnected tracks include the through holes 132 in the 8×5 arrangement.

At step 504, the embedded pins 136 associated with the receptacle 116 are coupled with the through holes 132. The coupling of the embedded pins 136 includes soldering of the embedded pins 136 with the printed circuit board 130. Further, the coupling of the embedded pins 136 is such that the embedded pins 136 extend from the respectable 116 and are coupled to the printed circuit board 130 fitted thereover. The receptacle 116 and the printed circuit board 130 coupled thereto into the enclosure 104 of the electrical connector assembly 100. The electrical connector assembly 100 is externally configured through the embedded pins 136 of the receptacle 116.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1. An electrical connector assembly comprising:
a receptacle including a plurality of embedded pins; and
a printed circuit board coupled to the plurality of embedded pins of the receptacle, the printed circuit board including a plurality of interconnected tracks provided thereon, wherein the plurality of interconnected tracks are arranged in a side by side relationship in a plurality of linear segments, each of the plurality of linear segments including a plurality of through holes,
wherein the embedded pins extend from the receptacle and are received into the respective through holes of the printed circuit board.

2. The electrical connector assembly of claim 1, wherein the receptacle and the printed circuit board coupled thereto form a unit configured to be received into an enclosure.

3. The electrical connector assembly of claim 1, wherein the electrical connector assembly is externally configurable via the plurality of embedded pins.

4. (canceled)

5. (canceled)

6. The electrical connector assembly of claim 1 further comprising a copper pad in a surrounding relationship with each of the plurality of through holes.

7. (canceled)

8. An electrical nnector assembly comprising:
an enclosure;
a receptacle coupled to the enclosure; the receptacle including a plurality of embedded pins; and
a printed circuit board coupled to the plurality of embedded pins of the receptacle, the printed circuit board including a plurality of interconnected tracks provided thereon, wherein the plurality of interconnected tracks are arranged in a side by side relationship in a plurality of linear segments. each of the plurality of linear segments including a plurality of through holes,
wherein the embedded pins extend from the receptacle and are received into the respective through holes of the printed circuit board,
wherein the receptacle and the printed circuit board are received into the enclosure.

9. The electrical connector assembly of claim 8, wherein the electrical connector assembly is externally configurable via the plurality of embedded pins.

10. (canceled)

11. (canceled)

12. The electrical connector assembly of claim 8 further comprising a copper pad in a surrounding relationship with each of the plurality of through holes.

13-18. (canceled)
